(19) United States
(12) Patent Application Publication
(10) Pub. No.: US 2018/0312300 A1
(43) Pub. Date: Nov. 1, 2018

(54) Bag with Zipper Closure and Side Folds and Method for Making such a Bag

(71) Applicant: Schur Technology A/S, Horsens (DK)

(72) Inventor: Henrik Pape, Horsens (DK)

(21) Appl. No.: 15/735,629

(22) PCT Filed: Jun. 15, 2016
(86) PCT No.: PCT/DK2016/050187

§ 371 Date: Dec. 12, 2017

(30) Foreign Application Priority Data
Jun. 15, 2015 (DK) PA 2015 70367

(51) Int. Cl. B65D 33/25; B31B 70/81

(52) U.S. Cl. CPC B65D 33/2508; B31B 2160/10; B31B 70/81

(57) ABSTRACT

There is disclosed a bag (101) with a zipper closure and a method for making such a bag. The bag is formed of a first (102) and a second (103) superposed flat side and folded side pieces (104) disposed between the flat sides of the bag and welded to edge areas at the side edges of the flat sides. The bag includes interacting zipper parts (114) in the form of a male part (120) and a female part (119) connected with each their flat side and extending from side edge to side edge. In order to achieve the largest possible opening of the bag, the folded side edges are extending from the bottom edge of the bag to the top edge of the bag. In the side pieces a thinning of material (123) is established in an area next to the areas in the flat sides where the zipper parts are disposed. Thus, the side pieces in the thinned area will have a material thickness enabling the male and female parts to engage each other while at the same time the material of the side pieces is clamped there between.

### FIELD OF THE INVENTION

The present invention concerns a bag with a zipper closure, wherein the bag is formed of a first and a second superposed flat side and folded, inserted side pieces disposed between the flat sides of the bag and welded to edge areas at the side edges of the flat sides, the bag including interacting zipper parts connected with each their flat side and extending from side edge to side edge.

The invention furthermore concerns a method for making a bag with a zipper closure, the bag being formed of a first and a second flat side that are mutually superposed, and side pieces that are inserted and folded between the flat sides of the bag and welded to edge areas at the side edges of the flat sides, the bag including interacting zipper parts in the form of a male part and a female part connected with each their flat side and extending from side edge to side edge.

The zipper parts are typically disposed in parallel with the top edge of the bag delimiting the bag opening and typically at a short distance from the top edge.

Such bags are usually made of plastic film where at least film sides that face each other are weldable plastic materials. Multi-layered films are used as well.

The bags can optionally be provided with folded bottom pieces for formation of standing bags, or the flat sides of the bag can be directly welded together at edge areas along the bottom edge of the bag.

### BACKGROUND OF THE INVENTION

Bags with folded side pieces are advantageous compared with flat bags where the two flat sides are directly connected with each other by welding of edge areas along the side edges and bottom edge of the bag. The advantage is a larger access opening. The opening appears with largely rectangular cross-section. This is an advantage by filling, which may occur rapidly, as well as there are advantages when removing the contents of the bag as access to the interior of the bag is easier.

When working with bags with zippers, there is a general difficulty in establishing a complete sealing in the area around the zipper parts of the zipper at the side edges of the bag. This problem is caused by differences in thickness appearing at bag edges that are welded together with zipper parts disposed there between.

By bags with folded side pieces there are additional difficulties as the side pieces, which consist of folded side pieces, will contribute to increasing the thickness difference in the area around the zipper parts at the flat sides of the bag.

From U.S. Pat. No. 6,796,932 it is known with bags of this type where the folded side pieces run from the bag bottom to a position under the zipper. The zipper extends from side edge to side edge of the bag. A welding of edge areas at side edges of the flat sides is established from the top edge to a position under the zipper. This means that the opening of the bag corresponds to the opening of a traditional flat bag formed of two flat sides that are welded directly to edge areas of each other at the side edges of the flat sides. From U.S. Pat. No. 6,796,932 is also know a method as described in the introduction.

In practice, it is also known to provide such bags with a film web fastened to one of the flat sides and having a width such that the upper part of the folded side pieces are fastened to the bag side, the film web running from side edge to side edge of the bag. The film web extends in direction towards the bag opening and past the zipper parts. This causes further differences in thickness.

For some years it has thus been a widespread problem to provide bags with zippers with folded side pieces and at the same time ensure that the opening of the bag has the same cross-sectional area as the cross-sectional area of the bag with the folded side edges in extended condition.

It has therefore been desirable to indicate a bag of the type mentioned in the introduction by which it is possible to establish a large opening.

### OBJECT OF THE INVENTION

It is the object of the invention to provide a side folded bag with zipper closure wherein the opening of the bag has the same cross-sectional area as the cross-sectional area of the bag with the folded side edges in extended condition, and where the problem of establishing a sealed bag in the area around the zipper at the side edges of the bag is solved in a simple way. It is further an object to provide a method for making such a bag.

### DESCRIPTION OF THE INVENTION

According to the present invention, this object is achieved by a bag of the kind mentioned in the introduction which is peculiar in that the folded side pieces extend from the bottom edge of the bag to the top edge of the bag, and that in the side pieces a thinning of material is established in an area where the zipper parts are disposed, such that the side pieces in the thinned area have a material thickness enabling the male and female parts to engage each other while at the same time the material of the side pieces is clamped there between.

The method according to the invention is peculiar in that the folded side pieces are disposed extending from the bottom edge of the bag to the top edge of the bag, that in the side pieces, prior to placing the zipper parts, a thinning of material is established in an area where the zipper parts are to be provided such that the side pieces in the thinned area are imparted a material thickness that enables the male and female parts to engage each other while at the same time the material of the side pieces is clamped there between.

By opening such a bag there is achieved an access opening appearing with a largely rectangular cross-section. This facilitates filling which can occur rapidly as well as it is easier to remove the contents of the bag as easier access to the interior of the bag is provided through the rectangular opening. The bag opening is about 15% larger than the opening of a corresponding size of bag where the flat sides are directly welded together.

By providing flat sides and side faces with materials and thicknesses determined by the application of the bag and providing the side pieces with a substantially smaller thickness in a delimited area opposite the zipper, it will be possible to squeeze the folded side pieces in between the zipper parts when the bag is closed. Hereby is established a completely tight closure.

Therefore it is essential that the side pieces have such a thickness that closing of the zipper parts will be possible by a squeezing force clamping the flat sides by the engagement between the two zipper parts.

In order to establish such a difference in material thickness it is necessary that a thinning is performed in a thick film. This is a relatively simple process.

Even if the zipper element will contribute to greater thickness there will no longer be any problem of bringing the welding jaws sufficiently together. Minor leaks appearing in the area around the zipper parts at the side edges of the flat sides will therefore not be a problem as the squeezing of the side folds between the zipper parts will establish a sealed closure of the bag.

Previously used modifications are therefore avoided by the solution according to the present invention. Apart from the use of shortened side pieces relative to the height of the bag between bottom edge and top edge as mentioned in the introduction, shortened zipper parts that did not extend entirely between side edges of the bag have also be used. By a bag according to the present invention it will thus be possible to make the bags in continuous webs where the zipper parts are likewise applied in long strip-like webs, and are only cut so as to form individual bag items wherein the zipper parts extend between the side edges of the bags.

According to a further embodiment, the bag according to the invention is peculiar in that that the zipper parts are strip-shaped, and that the male part has a projection, and that the female part is made of two resilient legs forming a concavity adapted to receive the projection of the male part and the folded side pieces when the projection of the male part is pressed in between the legs of the female part.

The projection can be mushroom-shaped or arrow-shaped, and the concavity of the female part is provided with a correspondingly designed undercutting in order to establish a secure fastening.

The two resilient legs of the female part enable pressing in of the male part between the legs in such a way that the plastic material from the side pieces will be retained by the resiliency of the legs.

According to a further embodiment, the bag according to the invention is peculiar in that the side pieces in the area opposite the thinned parts have a thickness between 5 and 25 μm, preferably between 10 and 20 μm. By commonly used zippers, this will provide a tight closure.

The size of the used zippers will typically be made with a total width of 2 mm and a height of 1.8 mm for a zipper design.

According to a further embodiment, the bag according to the invention is peculiar in that that the flat sides and the side pieces are formed of a plastic film with a thickness between 50 and 200 μm, preferably between 80 and 120 μm. These are commonly used film thicknesses.

According to a further embodiment, the bag according to the invention is peculiar in that that the superposed film webs are made of multi-layered films, that at least the outermost layers of the first and second flat sides facing each other are made of a weldable plastic material, and that at least the outermost layers of the side pieces facing the flat sides are made of a weldable plastic material.

According to a further embodiment, the bag according to the invention is peculiar in that at least the outermost layers of the first and the second flat sides facing away from each other are made of a non-weldable plastic material.

The bags will preferably be made of multi-layered films. Production is hereby facilitated as welding only occurs between the weldable materials that are brought to engage each other.

According to a further embodiment, the bag according to the invention is peculiar in that the weldable material is PE or PP, and that the non-weldable plastic material is PET, OPA or OPP. Irrespectively whether weldable and non-weldable plastic materials are preferred, it will also be possible to use other plastic materials. However, the mentioned plastic materials are in practice those used the most for making plastic bags.

According to a further embodiment, the bag according to the invention is peculiar in that the zipper parts are welded or glued to the flat sides. As mentioned, the zipper parts will be mounted on the side faces. This may be effected by welding and gluing directly upon the flat sides. The folded side pieces will therefore be clamped between interacting zipper parts when the bag is closed.

According to a further embodiment, the bag according to the invention is peculiar in that the thinning is formed by forming the side pieces of the bag of an extruded web with the thinning produced by extrusion. By extrusion of film webs with a flat nozzle it is simple to establish the thinning just by adapting the nozzle aperture of the flat nozzle to the desired profile for the side pieces.

When applying multi-layered films for making the first and the second plastic film it will be possible that the outermost layer of the flat sides have a thickness corresponding to the depth of the thinning. The thinning can hereby be provided in a simple way by the outermost layer in the multi-layered film having a thickness corresponding to the thickness of the second plastic film used for forming the side pieces. The thinning may alternatively be established by providing the outer film layers in webs that have a mutual width corresponding to the desired width of the thinning.

According to a further embodiment, the bag according to the invention is peculiar in that the bag is also provided with a folded bottom. Even if the bag above is explained as being a bag with side fold, the bag may optionally be provided with a folded bottom. The advantage of the invention will be achieved irrespectively of the design of the bag bottom.

According to a further embodiment, the method according to the invention is peculiar in that that the superposed flat sides are made of multi-layered films, that at least the outermost layers of the first and second flat sides facing each other are made of a weldable plastic material, and that at least the outermost layers of the side pieces facing the flat sides are made of a weldable plastic material.

According to a further embodiment, the method according to the invention is peculiar in that at least the outermost layers of the first and the second flat sides facing away from each other are made of a non-weldable plastic material.

According to a further embodiment, the method according to the invention is peculiar in that the weldable material is PE or PP, and that the non-weldable plastic material is PET, OPA or OPP.

The thinning has a width corresponding to the width of the zipper parts. It is possible to make the thinning with different widths if it is only ensured that the width of the thinning at least corresponds to the width of the zipper parts.

Methods of removing material can be applied as alternative to forming the thinning by extrusion. This may be effected by burning material away by a heating jaw or by abrading.

Generally, a bag according to the invention will be made by formation of webs.

Bags will thus be formed of bag webs of the type with side pieces and bottom pieces that are connected by the flat sides. Side pieces and bottom pieces will therefore usually be folded sides and/or bottoms. Between the two film webs folded film pieces are thus placed, forming the folded side pieces of the bag, and possibly bottom pieces as well. The web is cut up for forming the individual bags. When the bags are provided with zipper, the zipper parts will be disposed between two superposed bag webs such that they can interact for closing the formed bag. The zipper parts will be made in long lengths that are applied the bag webs before placing the side pieces.

An example of the making in principle of a bag web can e.g. be found in U.S. Pat. No. 6,796,932. However, the described method is to be adapted in that the side pieces extend across the entire width of the bag web and in that the film webs used for forming the side pieces are to be provided with thinnings opposite the position of the zipper.

### DESCRIPTION OF THE DRAWING

The invention will now be explained in more detail with reference to the accompanying schematic drawing, wherein

FIGS. 1 and 2 show a plan view and a top view, respectively of a prior art bag;

FIGS. 3 and 4 show views corresponding to FIGS. 1 and 2 of a bag according to the invention;

FIGS. 5A and 5B show sectional views on the line V-V in FIG. 3 with the bag in open and closed condition, respectively;

FIG. 6 shows a schematic view of a film web for use in making the side pieces;

FIG. 7 shows an item cut from the film web shown in FIG. 6 for use in formation of the side pieces;

FIG. 8 shows a presentation in principle where the items shown in FIG. 7 are disposed between the two film webs for forming flat sides and side faces of the bag item; and

FIG. 9 shows a schematic view corresponding to FIG. 6 of an alternative film web for use in making the side pieces.

### DETAILED DESCRIPTION OF EMBODIMENTS OF THE INVENTION

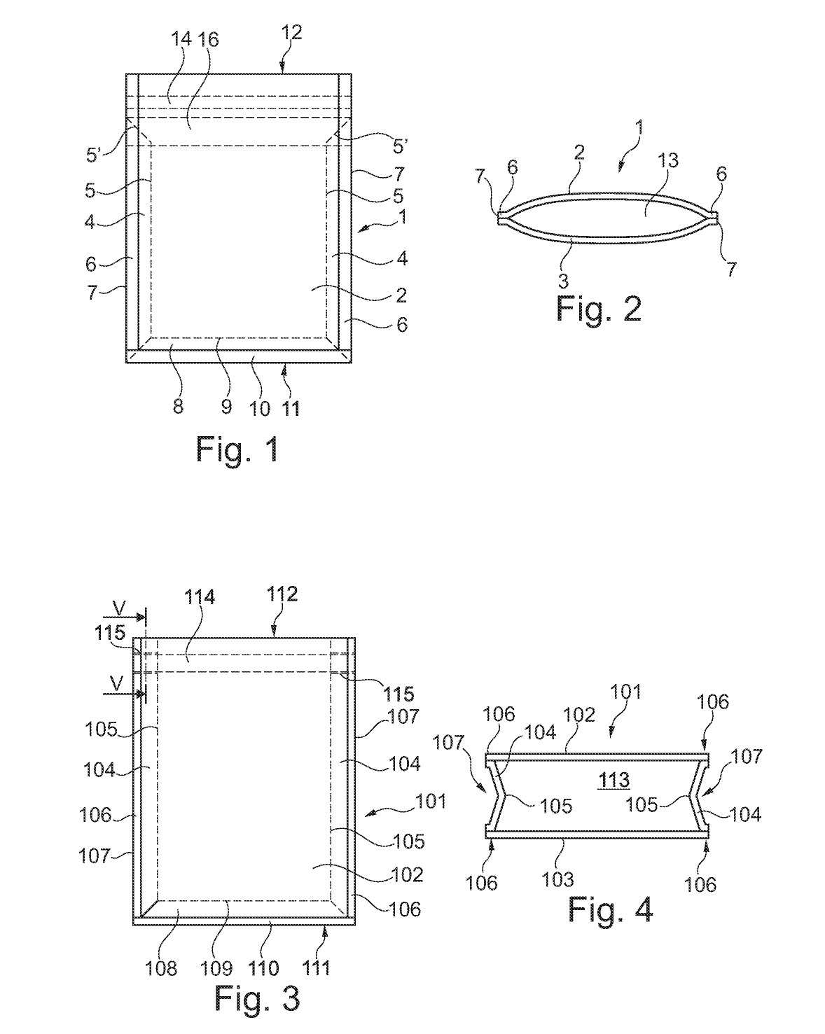

In the description, identical or corresponding elements will be provided with the same designations, however such that the embodiment associated with the invention will have designations of the prior art embodiment but added 100. A prior art bag 1 shown in FIGS. 1 and 2 will therefore be designated as the bag 101 in FIGS. 3 and 4 that show a bag according to the invention.

In FIGS. 1 and 2 is seen a bag 1 according to prior art. The bag 1 is formed of a first flat side 2 and a second flat side 3. Folded side pieces 4 are disposed between the two flat sides. Broken lines 5 in FIG. 1 illustrate a folding that at the same time indicates the extension of the folded side pieces 4. The side pieces 4 are welded to the flat sides 2, 3 in edge areas 6 adjacent to the side edges 7 of the flat sides. At the bottom, the bag is provided with a folded bottom piece 8, and the extension of the latter is shown by the broken line 9 indicating the folding of the folded bottom piece 8. The bottom piece 8 is welded also to the flat sides at an edge area 10 adjacent to the lower side edge 11 of the bag.

At the upper side edge 12 of the bag is provided an opening 13 (see FIG. 2).

The bag 1 is provided with a zipper 14 running in parallel with the upper side edge 12 of the bag surrounding the opening 13. The zipper 14 runs between two opposing side edges 7 of the bag.

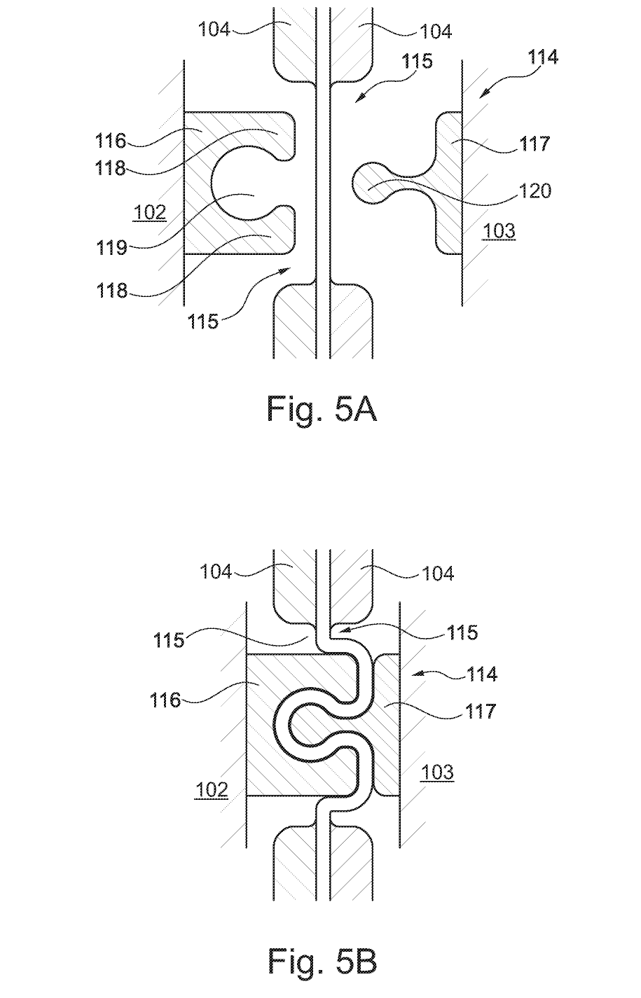

The zipper is formed of strip-shaped zipper parts 116 and 117, which will be explained in more detail with reference to FIGS. 5A and 5B.

In FIG. 1 is seen that the side folds 4 have an upper oblique edge 5′ located at a position under the zipper 14. A film strip 16 covers the upper end of the side pieces 4, gluing the latter to one of the flat sides 2, 3 of the bag in order to ensure a tight closure of the bag.

In FIG. 2, the bag 1 shown in FIG. 1 is seen from above when opened. Therefore it appears that the opening 13 is lenticular, extending between the two direct weldings of the flat sides 2, 3 in the edge areas 6.

Irrespectively that the bag 1 at a position under the zipper 14 is provided with folded side pieces 4, which enables increased volume and a larger cross-section of the bag, the bag will have the shape appearing on FIG. 2 in the opening 13.

A bag 101 according to the invention is shown in FIGS. 3 and 4. This bag differs primarily in that the folded side pieces 104 extend over the entire height of the bag, up to the top edge 112 surrounding the opening 113 of the bag. Moreover, the side pieces 104 are modified by formation of a thinning 115, as explained below. Broken lines 105 in FIG. 3 illustrate a folding which at the same time indicates the extension of the folded side pieces 104.

Particularly clearly appearing on FIG. 4, the folded side pieces 104 are welded at the edge areas 106. When opening the bag, the folded side pieces 104 will be unfolded as illustrated in FIG. 4. The opening 113 of the bag hereby appears with a largely rectangular cross-section. The opening 113 will therefore be substantially larger than the opening 13 shown in FIG. 2.

A thinning 115 is formed in the side pieces 104 at the location of the zipper 114. This thinning 115 appears more clearly on FIGS. 5-8.

FIGS. 5A and 5B show the situation of the zipper 114 in open and closed condition, respectively.

The zipper 114 consists of the zipper parts 116 and 117. The zipper element 116 is a female part. A cross-section of a strip-shaped element is shown. The female part has to resilient legs 118 surrounding a concavity 119. The male part 117 is also strip-shaped, having a strip-shaped projection 120 intended for reception in the concavity 119.

As illustrated in FIGS. 5A and 5B, the folded side pieces 104 in the area at the zipper are superposed each other such that there are two folded parts of a side piece opposite the zipper 114. The thinning 115 is located opposite the two zipper parts 116 and 117.

When the zipper parts 116 and 117 are brought to engage as illustrated in FIG. 5B, the two thin material layers from the side pieces 104 will be clamped within the concavity 119 and secured by the engagement of the projection 120. Due to the resiliency of the legs 118, the additional material thickness located opposite the side pieces can be accommodated in the zipper.

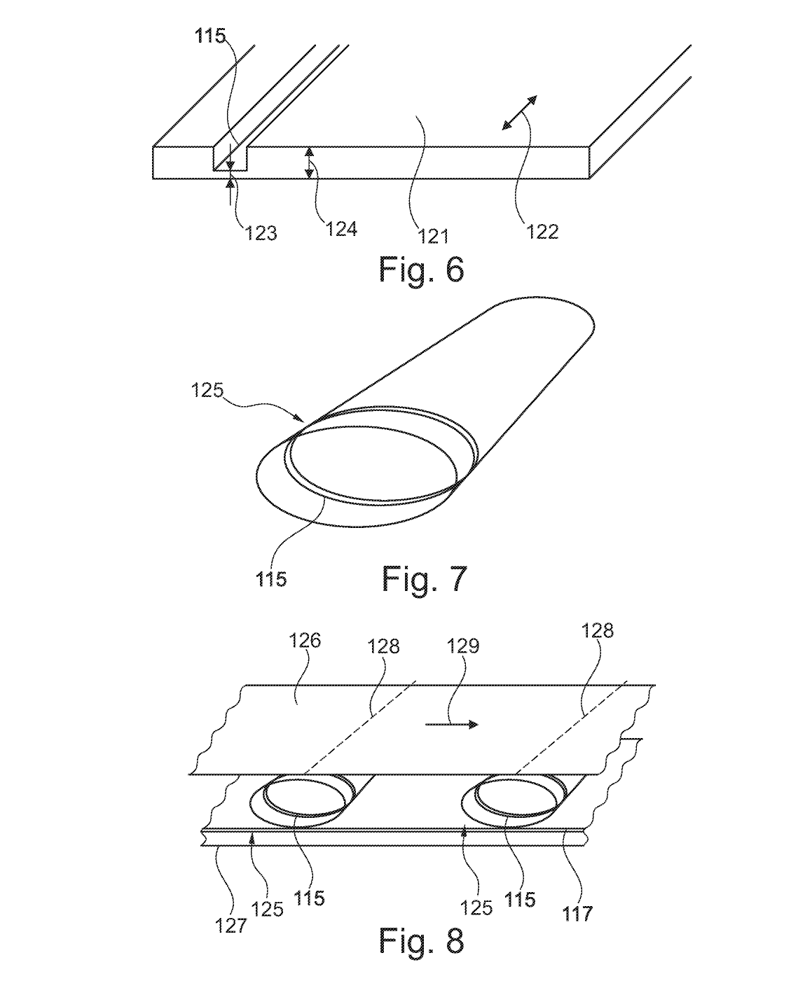

FIG. 6 illustrates a film web 121 in which a thinning 115 is formed. The arrow 122 indicates the direction of producing the web. The web is made by extrusion in a flat nozzle such that the thinning 115 appears in the film web 121 during the making thereof. It appears here that the material thickness 123 at the thinning is significantly smaller than the material thickness 124 of the film web 121. The thinning 115 appears as a recess with a material thickness 124 at each side of the thinning 115. The web can alternatively be made as a multi-layered film where the film layers form a reduced material thickness 123 at the thinning.

The material thickness opposite the thinning will typically be between 5 and 25 μm, preferably between 10 and 20 μm. The material thickness of the plastic film will typically be between 50 and 200 μm, preferably between 80 and 120 μm.

FIG. 7 shows an item 125 cut from the material web 121 and then folded for forming a tubular shape with the thinning 115 disposed externally of the tubular shape.

FIG. 8 illustrates how the tubular items 125 are disposed between a first film web 126 and a second film web 127 that are used for forming the first and the second bag sides 102 and 103, respectively.

The items 125 will thus be squeezed flat when the film webs 126 and 127 are joined. Then, cutting at cutting lines marked by the broken lines 128 is performed. An item will thus constitute a side piece formed in a bag which is made by a method described in principle in U.S. Pat. No. 6,796,932.

In FIG. 8 appears one zipper element 117 fastened to the film web 127 at a position before the items 125 are applied. The zipper element 116 will be placed at the bottom side of the film web 126.

When the items 125 are placed between the two film webs, the two outwardly facing thinnings 115 will therefore be disposed opposite the position of the zipper parts 116, 117.

Alternatively, it is possible to have thinnings 115 at the opposite side of the film webs.

The making of the bags takes place by moving the film webs in the direction indicated by the arrow 129.

It is noted that FIG. 8 only illustrates part of the production process as reference incidentally is made to the description of the principle of a production process given in U.S. Pat. No. 6,796,932.

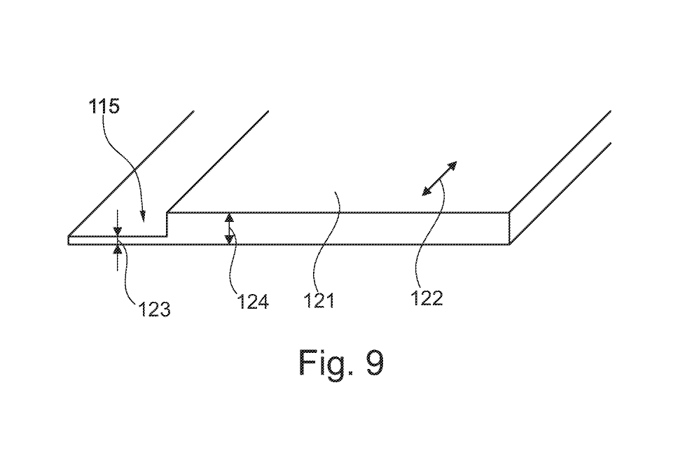

FIG. 9 illustrates an alternative film web 121 in which a thinning 115 is formed. The arrow 122 indicates the direction of producing the web. The web is made by extrusion in a flat nozzle such that the thinning 115 appears in the film web 121 during the making thereof. It appears here that the material thickness 123 at the thinning is significantly smaller than the material thickness 124 of the film web 121. The thinning 115 appears as an edge area with a material thickness 124 only at one side of the thinning 115. The web can alternatively be made as a multi-layered film where the film layers form a reduced material thickness 123 at the thinning.

1. A bag (101) with a zipper closure, wherein the bag is formed of:
a first (102) and a second (103) superposed flat side formed of a first plastic film and
folded side pieces (104) formed of a second plastic film and which are disposed between the flat sides (102,103) of the bag and welded to edge areas (106) at the side edges of the flat sides (102,103), the bag including interacting zipper parts (116,117) in the form of a male part (117) and a female part (116) connected with each their flat side (102,103) and extending from side edge (107) to side edge (107) of the bag (101), wherein the folded side pieces (104) extend from the bottom edge of the bag to the top edge of the bag, and wherein in the side pieces (104) a thinning (115) of material is established in an area opposite to the zipper parts disposed on the flat sides (102,103), such that the side pieces (104) in the thinned area have a material thickness enabling the male and female parts (117,116) to engage each other while at the same time the material of the side pieces is clamped there between, and wherein the second plastic film (121) comprising the thinning (115) is made of a multi-layered film where the film layers form a reduced material thickness (123) at the thinning (115).

2. A bag according to claim 1, wherein the zipper parts are strip-shaped, and wherein the male part has a projection, and that the female part is made of two resilient legs forming a concavity adapted to receive the projection of the male part and the folded side pieces when the projection of the male part is pressed in between the legs of the female part.

3. A bag according to claim 1, wherein the side pieces in the area opposite the thinned parts have a thickness between 5 and 25 μm, preferably between 10 and 20 μm.

4. A bag according to claim 1, wherein the flat sides and the side pieces are formed of a plastic film with a thickness between 50 and 200 μm, preferably between 80 and 120 μm.

5. A bag according to claim 1, wherein the superposed first and second flat side are made of multi-layered films, that at least the outermost layers of the first and second flat sides facing each other are made of a weldable plastic material, and wherein at least the outermost layers of the side pieces facing the flat sides are made of a weldable plastic material.

6. A bag according to claim 5, wherein at least the outermost layers of the first and the second flat sides facing away from each other are made of a non-weldable plastic material.

7. A bag according to claim 5, wherein the weldable material is PE or PP, and that the non-weldable plastic material is PET, OPA or OPP.

8. A bag according to claim 1, wherein the zipper parts are welded or glued to the flat sides.

9. A bag according to claim 1, wherein the thinning is formed by forming the side pieces of the bag of an extruded web with the thinning produced by extrusion.

10. A bag according to claim 1, wherein the bag is also provided with a folded bottom.

11. A method for making a bag (101) with a zipper closure, the bag being formed of a first and a second flat side (102,103) that are mutually superposed, and side pieces (104) that are inserted and folded between the flat sides (102,103) of the bag and welded to edge areas (106) at the side edges of the flat sides, the bag including interacting zipper parts (116,117) in the form of a male part (117) and a female part (116) connected with each their flat side and extending from side edge (107) to side edge (107) of the bag (101), wherein the method comprises steps of providing the first and the second flat side (102,103), superposing the flat sides and providing zipper parts (116,117) and placing these on the flat sides (102,103), and disposing folded side pieces (104) between the flat sides extending from the bottom edge of the bag to the top edge of the bag, that in the side pieces, prior to placing the zipper parts (116,117), a thinning (115) of material is established in an area opposite to the zipper parts provided on the flat sides such that the side pieces in the thinned area are imparted a material thickness that enables the male and female parts to engage each other while at the same time the material of the side pieces (104) is clamped there between, and wherein the second plastic film (121) comprising the thinning (115) is made of a multi-layered film where the film layers form a reduced material thickness (123) at the thinning (115).

12. A method according to claim 11, wherein the superposed flat sides are made of multi-layered films, that at least the outermost layers of the first and second flat sides facing each other are made of a weldable plastic material, and that at least the outermost layers of the side pieces facing the flat sides are made of a weldable plastic material.

13. A method according to claim 11, wherein at least the outermost layers of the first and the second flat sides facing away from each other are made of a non-weldable plastic material.

14. A method according to claim 12, wherein the weldable material is PE or PP, and that the non-weldable plastic material is PET, OPA or OPP.

15. A method according to claim 11, wherein the bags are made in continuous webs where the zipper parts are applied in long strip-like webs, and that the webs are cut so as to form individual bag items wherein the zipper parts extend between the side edges of the bags.
